(19) United States
(12) Patent Application Publication
(10) Pub. No.: US 2024/0410517 A1
(43) Pub. Date: Dec. 12, 2024

(54) A TABLET HOLDER FOR USE IN SUPPORTING OPTICAL WIRELESS COMMUNICATION

(71) Applicant: SIGNIFY HOLDING B.V., EINDHOVEN (NL)

(72) Inventor: VINCENT JOHANNES JACOBUS VAN MONTFORT, SITTARD (NL)

(21) Appl. No.: 18/702,859

(22) PCT Filed: Oct. 18, 2022
(86) PCT No.: PCT/EP2022/078913

§ 371 Date: Apr. 19, 2024

(30) Foreign Application Priority Data
Oct. 22, 2021 (EP) 21204148.7
Feb. 7, 2022 (EP) 22155364.7

(51) Int. Cl. F16M 11/10

(52) U.S. Cl. CPC F16M 11/10; F16M 2200/022

(57) ABSTRACT

This invention discloses a tablet holder (100) for use in supporting optical wireless communication. The tablet holder (100) comprises a cover (110) configured to hold a tablet (200); a rotatable housing (120) attached to the cover (110); an optical transceiver (125) configured to carry out optical wireless communication (300); wherein the optical transceiver (125) is fixed in the rotatable housing (120), and an orientation of the optical transceiver (125) is determined by a position of the rotatable housing (120); a rotatable stand (130) attached to the cover (110); a motion transmission subsystem (140) mechanically coupled to the rotatable housing (120) and the rotatable stand (130); wherein the motion transmission subsystem is configured to translate the rotation of the rotatable stand (130) relative to the cover (110) into a reversed rotation of the rotatable housing (120) relative to the cover (110), such that when the tablet holder (100) is placed on a supporting surface, the orientation of the optical transceiver (125) is the same when the rotatable stand (130) is in a closed state or is rotated to an extended state with the rotatable stand (130) having a certain angle (θ) against the supporting surface.

### FIELD OF THE INVENTION

The invention relates to the field of optical wireless communication networks, such as Li-Fi networks. More particularly, various methods, apparatus, systems, and computer-readable media are disclosed herein related to a time-alignment subsystem and method for use with an optical transceiver with more than one optical front ends.

### BACKGROUND OF THE INVENTION

Nowadays computer or tablet assisted education is more and more popular, and this trend is penetrating towards younger students, such as in primary schools. Each student may use their own computer or tablet to learn the subjects with their own pace. This approach also reduces the burden on teaches. For example, exams may also be carried out online, and marking is done automatically. To facilitate this new education approach, it is also important to provide reliable and high-speed Internet connection in the classroom. Conventionally, wired connections are considered to be cumbersome due to the cables, and alternatively. Wi-Fi access points (APs) are deployed to serve this purpose. However, Wi-Fi based connection may not satisfy the new application scenario, either. Due to the mutual interference among multiple Wi-Fi APs, the Wi-Fi APs cannot be deployed with a high density, resulting in the situation that a large number of users are associated with a single Wi-Fi AP. However, this also means significant overhead in the system and reduced achievable per-user performance, such that the throughput per user. Furthermore, in some countries the use of radio-waves in primary schools might be banned by local regulations. As thus, Wi-Fi is not always a solution there.

Recently, light fidelity (Li-Fi) is drawing more and more attention with its intrinsic security enhancement and capability to support higher data rates over the available bandwidth in visible light, Ultraviolet (UV), and Infrared (IR) spectra. Furthermore, Li-Fi is directional and shielded by light blocking materials, which provides it with the potential to deploy a larger number of access points by spatially reusing the same bandwidth. These key advantages over wireless radio frequency communication make Li-Fi a promising secure solution to mitigate the pressure on the crowded radio spectrum for IoT applications and indoor wireless access. Further benefits of Li-Fi may include guaranteed bandwidth for a certain user, and the ability to function robustly in areas otherwise susceptible to electromagnetic interference. Therefore, Li-Fi is a very promising technology to enable the next generation of immersive connectivity.

WO2019009878A1 relates to an accessory pivot that comprises a driven gear fixed to a computing device accessory, a hinge gear engaged with a hinge of a computing device, and a transfer bar engaged with the driven gear and the hinge gear to actuate the driven gear upon the transfer bar being actuated by the hinge gear.

### SUMMARY OF THE INVENTION

To satisfy certain indoor applications, such as in office spaces, classrooms, conference halls, optical wireless communication, or Li-Fi communication, turns to be a promising solution to provide reliable connections to a big audience Since optical wireless communication has the line-of-sight (LoS) propagation property, optical access points (APs) can be deployed in a high density without interfering each other. And then, each individual user may be provided with a sufficiently high throughput. However, also due to the LoS property, the coverage area of an optical transmitter and the field-of-view (FoV) of an optical receiver may be relatively limited as compared to radio frequency-based communication. Therefore, a good beam alignment between two remote devices is required to establish a stable and high-performance optical wireless link.

For certain user scenarios, such as in schools, it is also highly desirable that the beam alignment may be carried out automatically by the device with little involvement of the user. For example, no matter if a student puts the tablet in a slant position for reading or in a flat position for typing, the optical wireless interface shall always be in the right orientation for a stable LiFi connection, and the student is not required to manually align the beam upon changing the position of the tablet.

In view of the above, the present disclosure is directed to a tablet holder comprising an optical wireless interface, and the beam alignment of the optical wireless interface is implemented automatically via a motion transmission subsystem comprised therein.

In accordance with a first aspect of the invention a tablet holder is provided. A tablet holder for use in supporting optical wireless communication, the tablet holder comprising a cover configured to hold a tablet; a rotatable housing attached to the cover; an optical transceiver configured to carry out optical wireless communication; wherein the optical transceiver is fixed in the rotatable housing, and an orientation of the optical transceiver is determined by a position of the rotatable housing; a rotatable stand attached to the cover; a motion transmission subsystem mechanically coupled to or integrated in the rotatable housing and the rotatable stand; wherein the motion transmission subsystem is configured to translate the rotation of the rotatable stand relative to the cover into a reversed rotation of the rotatable housing relative to the cover, such that when the tablet holder is placed on a supporting surface, the orientation of the optical transceiver is the same when the rotatable stand is in a closed state or is rotated to an extended state with the rotatable stand having a certain angle (θ) against the supporting surface.

The rotatable housing and the rotatable stand are both attached to the cover and are configured to rotate relative to the cover. The rotatable housing and the rotatable stand are rotated in a correlated manner via the motion transmission subsystem. The directions of the two rotations are opposite to each other. When the rotatable stand is in a closed state, the tablet is flat on the supporting surface, such as the table or desk. When the rotatable stand is in an extended state, the rotatable stand is in a slant position as compared to the supporting surface. The two states define the two stable positions of the rotatable stand, as well as the cover and the tablet. The effect is that the optical transceiver is oriented to the same direction when the rotatable stand is either in a closed state or is rotated to an extended state, given that the optical transceiver is fixed in the rotatable housing, and the orientation of the optical transceiver is determined by the rotation or position of the rotatable housing.

The optical transceiver comprises at least a light source and a light sensor. A light source can be a Light-emitting diode (LED), a Laser diode (LD), a Vertical Cavity Surface Emitting Laser (VCSEL), or an array of LED, LD, or VESEL A light sensor can be a photodiode, an avalanche diode, or another type of light sensor. Sometimes a light sensor is also called as a photo detector, a light detector, or a photo sensor.

The tablet holder may further comprise a data interface configured to support bi-directional communication between the optical transceiver and the tablet. Since a USB interface is widely used in consumer electronic devices, preferably the optical transceiver comprised in the tablet holder is connected to the tablet via the USB interface of the tablet. Therefore, to enable a tablet with optical wireless communication (OWC) capability, the most convenient approach is to have an OWC interface connected or communicatively coupled to the tablet as a separate entity, such as a USB dongle. Alternatively, the data interface may also be a wireless communication interface suitable for short distance high-speed data communication.

Advantageously, the translation of the rotations involves a certain ratio, which is determined by the length (h) of the rotatable stand, the size of the tablet, and the certain angle (θ).

The rotations of the rotatable housing and the rotatable stand are correlated via the certain ratio. In another word, the certain ratio defines the speeds of rotations of the two components Since the size of the tablet is fixed, when the length (h) of the rotatable stand and the certain angle (θ) are decided, the certain ratio can be calculated geometrically.

Beneficially, the length (h) of the rotatable stand is adjustable.

It may also be possible that the length of the rotatable stand can be adjusted, and then with the certain ratio is fixed, a different slant angle of the tablet may be achieved by adjusting the length of the rotatable stand. This may provide more flexibility to the system.

Preferably, the certain angle (θ) is in the range of 0 to 90 degrees.

Depending on the application scenarios, the deployment of the optical access point, and the profile of a targeted user group, the certain angle (θ) may vary in the range of 0 to 90 degrees.

In one example, the certain angle (θ) is 45 degrees.

In a preferred setup, the certain ratio is 2 to 1, when the rotatable stand is of the same length as the side of the tablet on the rotation plane of the rotatable stand.

In this example, the rotation of the rotatable stand is correlated to the rotation of the rotatable housing according to a 2 to 1 ratio. If the rotatable stand is of the same length as the side of the tablet on the rotation plane of the rotatable stand, from a side view, when the rotatable stand is rotated 90 degrees counterclockwise, the rotatable housing is rotated 45 degrees clockwise.

Advantageously, the optical wireless communication is Li-Fi communication.

As a derivative of optical wireless communication, Li-Fi provides high data rate communication over the available bandwidth in visible light, Ultraviolet (UV), and Infrared (IR) spectra. There are different standardization activities related to Li-Fi communication. ITU G.9991 standard for indoor Visible Light Communication (VLC) is one of the earliest standard for high-speed wireless communications with visible light and infrared. IEEE has formed IEEE 802.11bb Task Force to develop and ratify the Global standard for LiFi.

In a preferred setup, the rotatable housing is a cylinder truncated longitudinally.

Beneficially, the cylindrical surface of the cylinder may be used to integrate a rotation element of the rotation transmission subsystem, and the truncated surface may be used to place the optical components of the optical transceiver.

Advantageously, the motion transmission subsystem comprises at least one of a pair of gears, a pair of friction wheels, a pair of friction belts, a pair of chain and sprocket.

The motion transmission subsystem is used to transmit a rotation motion from one part of the motion transmission subsystem to another part of the motion transmission subsystem without really altering the nature of the motion, which may be implemented via different types of components or component pairs. Depending on the type of components or component pairs adopted in the motion transmission subsystem, the speed of rotations of the corresponding pair may be controlled or correlated according to different mechanisms. For example, if the motion transmission subsystem comprises a gear solution, the certain ratio can be implemented via a gear ratio. For friction-based motion transmission subsystems, the certain ratio can be implemented via selecting suitable materials or diameters of the two mating elements.

In one example, the motion transmission subsystem is a gear solution comprising a first gear of the gear solution coupled to or integrated in the rotatable stand and a second gear of the gear solution coupled to or integrated in the rotatable housing.

The pair of mating elements in the motion transmission subsystem are mechanically coupled to or integrated in the rotatable stand and the rotatable housing, respectively. In one option, the mating elements may be constructed as separated components mechanically coupled to the rotatable stand and the rotatable housing. In another option, the mating elements may be constructed as part of the rotatable stand and the rotatable housing. For example, part of contacting surfaces of the rotatable stand and the rotatable housing may have protrusions functioning as gear teeth.

In another example, the gear solution comprises more than one pair of mating gears, with each pair of mating gears having a different gear ratio and coupled to or integrated in the rotatable stand and the rotatable housing, respectively; and the gear solution is configured to engage one pair of mating gears each time.

In order to support different slant angles, it is convenient to have different gear ratios available. Then depending on a certain application scenario, the user may opt for one pair of mating gears with a certain gear ratio that is corresponding to a desirable slant angle of the rotatable stand or the tablet. Note that when one pair of mating gears are engaged, all the other pairs are free from contact.

The selection among different pairs of mating gears may be used as an alternative to or in combination with the other option on adjusting the length (h) of the rotatable stand.

Beneficially, the motion transmission subsystem comprises an end position of either the rotatable housing or the rotatable stand, and the end position corresponds to a position where the rotatable stand has the certain angle (θ) against the supporting surface.

To allow the rotations of the rotatable stand and the rotatable housing stop automatically when the rotatable stand has the certain angle (θ) against the supporting surface, the motion transmission subsystem further comprises an end position. The end position may be deployed on a mechanical component of the motion transmission subsystem, which is coupled to either the rotatable housing or the rotatable stand, or both, such as on the first gear, or the second gear, or both. One example is that the teeth of the gear or gears stop after the end position.

In one example, the optical transceiver is configured to carry out optical wireless communication with an optical access point, and the orientation of the optical transceiver remains facing the optical access point when the rotatable stand is in the closed state or is rotated to the extended state with the rotatable stand having the certain angle (θ) against the supporting surface.

An optical wireless communication (OWC) access point, such as a Li-Fi access point (AP), provides electronic devices or end devices within the corresponding optical cell access to an external network via an optical wireless link. The OWC access point can also support bi-directional optical links with more than one end device at the same time, forming a point-to-multi-point (P2MP) system.

Optical APs is typically deployed on the ceiling. Advantageously, optical APs are integrated in or coupled to luminaries on the ceiling. Therefore, it is important that in both states of the tablet holder the optical transceiver faces vertically towards the ceiling to maintain a stable connection with the corresponding optical AP.

Preferably, the optical transceiver has a beam angle not larger than 60 degrees.

Beam angle or beam width is the aperture angle from where most of the power is radiated. For example, the half power beam width is the angle between the half-power (−3 dB) points of the main lobe of the radiation pattern. For the horizontal plane, beam angle or beam width is usually expressed in degrees.

To provide a relatively large coverage area, a wide beam angle may be used for an optical transceiver. However, the relatively wide beam may result in significant reduction in received optical power at a remote device side, due to a high path loss and a power consumption limitation of the transmitter side. Thus, the throughput to be achieved on a wide-angle link is also reduced accordingly. Therefore, the beam angle or beam width of the optical transceiver is typically smaller than 60 degrees.

More preferably, the optical transceiver has a beam angle not larger than 30 degrees.

To support a certain data rate, it is beneficial to use a narrower beam to reduce the power consumption of the optical transceiver. Therefore, a beam angle or beam width is typically not larger than 30 degrees.

### BRIEF DESCRIPTION OF THE DRAWINGS

In the drawings, like reference characters generally refer to the same parts throughout the different figures. Also, the drawings are not necessarily to scale, emphasis instead generally being placed upon illustrating the principles of the invention.

FIG. 1 demonstrates a tablet holder according to the present invention:

FIG. 2 illustrates a side view of a tablet holder with a rotatable stand in a closed state;

FIG. 3 illustrates a side x-section view of a tablet holder with a rotatable stand in a closed state;

FIG. 4 illustrates a side view of a tablet holder with a rotatable stand in an extended state;

FIG. 5 illustrates a side x-section view of a tablet holder with a rotatable stand in an extended state;

FIG. 6 demonstrates an example of the rotations of a rotatable stand and a rotatable housing; and

FIG. 7 demonstrates another example of the rotations of a rotatable stand and a rotatable housing.

### DETAILED DESCRIPTION OF EMBODIMENTS

The embodiments set forth below represent information to enable those skilled in the art to practice the embodiments. Upon reading the following description in light of the accompanying drawings, those skilled in the art will understand the concepts of the disclosure and will recognize applications of these concepts not particularly addressed herein. It should be understood that these concepts and applications fall within the scope of the disclosure.

This invention is related a tablet holder for use in supporting optical wireless communication (OWC), which operates at an optical band, such as in visible light, Ultraviolet (UV), and Infrared (IR) spectra. The optical transceiver comprised in the tablet holder may be used to establish a high-speed communication link with an optical access point or another remote device, which has a direct and unobstructed path, or a Line-of-Sight path, from the optical transceiver.

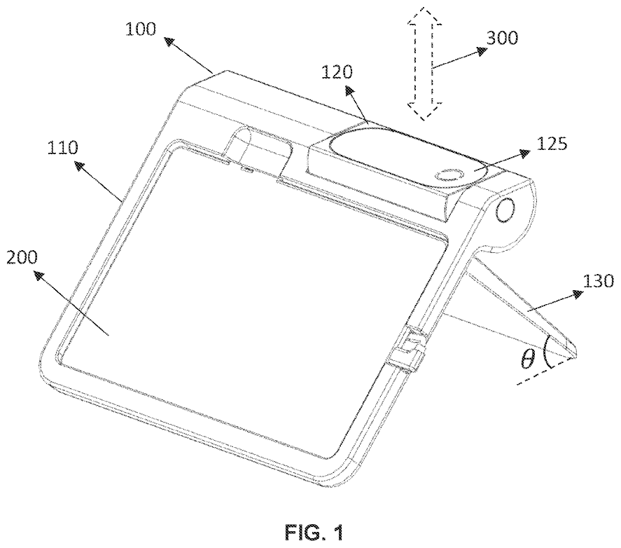

FIG. 1 demonstrates such a tablet holder 100 according to the present invention. As a basic setup, the tablet holder 100 comprises a cover 110, a rotatable housing 120, and a rotatable stand 130. The cover 110 is configured to hold and protect a tablet 200. The rotatable housing 120 and the rotatable stand 130 are both attached to the cover 110, and the rotations of both components are relative to the cover 110. The rotatable housing 120 comprises an optical transceiver 125 configured to carry out optical wireless communication 300. An optical access point is typically mounted on the ceiling, and hence, the optical transceiver 125 needs to face upwards when the tablet is either placed flat on the supporting surface, such as a table or a desk, or placed in a slanted position against the supporting surface.

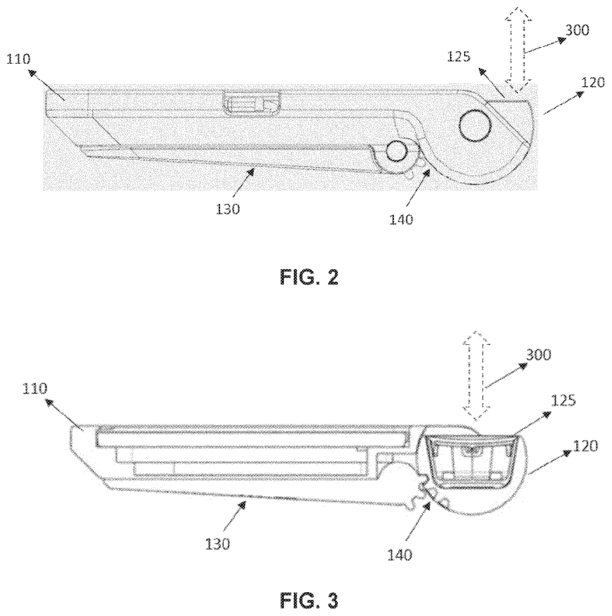

FIG. 2 illustrates a side view of a tablet holder 100 with a rotatable stand 130 in a closed state. When the rotatable stand 130 is closed, the tablet 200 lies flat on the supporting surface. This may be suitable for the user to type on the tablet 200. A motion transmission subsystem 140 is mechanically coupled to or integrated in the rotatable housing 120 and the rotatable stand 130, respectively. For illustration purpose, the motion transmission subsystem 140 is constructed in this example as a pair of mating gears integrated as part of the rotatable stand and the rotatable housing, such that part of contacting surfaces of the rotatable stand and the rotatable housing have protrusions functioning as gear teeth. The motion transmission subsystem 140 may also be implemented as a pair of friction wheels, a pair of friction belts, or a pair of chain and sprocket.

FIG. 3 illustrates a side x-section view of a tablet holder 100 with a rotatable stand 130 in the closed state. The optical transceiver 125 is fixed in the rotatable housing 120, and the orientation of the optical transceiver 125 is determined by the position of the rotatable housing 120. In this example, the rotatable housing 120 is a cylinder truncated longitudinally. The truncated surface is used to place the optical components of the optical transceiver 125, and part of the cylindrical surface is used to integrate a rotation element of the rotation transmission subsystem 140.

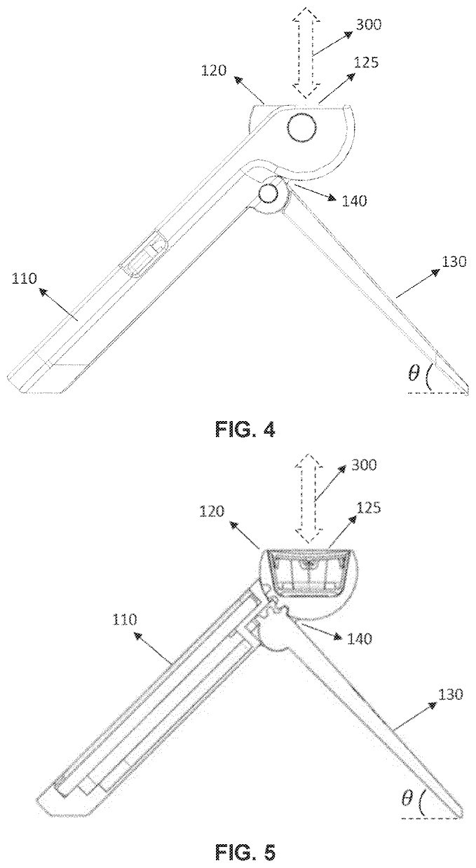

FIG. 4 illustrates a side view of a tablet holder 100 with a rotatable stand 130 in an extended state, wherein the rotatable stand 130 has a certain angle (θ) against the supporting surface. Accordingly, the tablet 200 is also placed with a slant angle against the supporting surface, which may be more convenient for the user to read texts or watch videos on the screen of the tablet 200. Similarly, FIG. 5 illustrates a side x-section view of a tablet holder with a rotatable stand in the extended state.

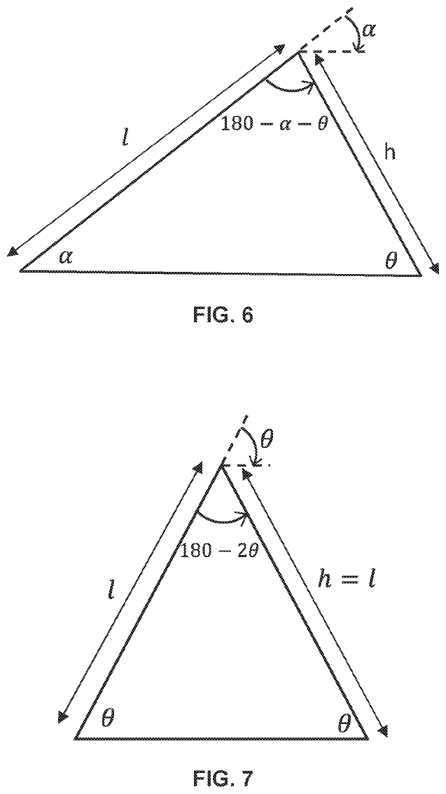

FIG. 6 demonstrates an example of the rotations of a rotatable stand 130 and a rotatable housing 120. The length of the rotatable stand 130 is h. The length of the tablet 200 on the rotation plane of the rotatable stand 130 is 1. When the rotatable stand 130 has a certain angle (θ) against the supporting surface, the rotation angles of the rotatable housing 120 and the rotatable stand 130 can be calculated geometrically, which are α and 180-α-θ respectively as indicated in FIG. 6. The two rotations are of opposite directions. The certain ratio defining the rotation translation is

$$\frac{180 - α - θ}{α} .$$

As a further example shown in FIG. 7, the length of the rotatable stand 130 h is the same as the length of the tablet 200 on the rotation plane of the rotatable stand 130 l. And then the certain ratio turns to be

$$\frac{180 - 2 θ}{θ} .$$

When θ is 45 degrees, the ratio is 2:1; and when θ is 60 degrees, the ratio is 1:1.

By correlating the rotations of the rotatable stand 130 and the rotatable housing 120 via the certain ratio, the orientation of the optical transceiver 125 remains in the right direction when the rotatable stand 130 is in either the closed state or in the extended state. Therefore, no user intervention will be required for the beam alignment to carry out optical wireless communication.

1. A tablet holder for use in supporting optical wireless communication, the tablet holder comprising:
a cover configured to hold a tablet;
a rotatable housing attached to the cover;
an optical transceiver configured to carry out optical wireless communication; wherein the optical transceiver is fixed in the rotatable housing, and an orientation of the optical transceiver is determined by a position of the rotatable housing;
a rotatable stand attached to the cover; and
a motion transmission subsystem mechanically coupled to or integrated in the rotatable housing and the rotatable stand; wherein the motion transmission subsystem is configured to translate the rotation of the rotatable stand relative to the cover into a reversed rotation of the rotatable housing relative to the cover, such that when the tablet holder is placed on a supporting surface, the orientation of the optical transceiver is the same when the rotatable stand is in a closed state or is rotated to an extended state with the rotatable stand having a certain angle against the supporting surface.

2. The tablet holder of claim 1, wherein the translation of the rotations involves a certain ratio, which is determined by the length of the rotatable stand, the size of the tablet, and the certain angle.

3. The tablet holder of claim 1, wherein the length of the rotatable stand is adjustable.

4. The tablet holder of claim 1, wherein the certain angle is in the range of 0 to 90 degrees.

5. The tablet holder of claim 4, wherein the certain angle is 45 degrees.

6. The tablet holder of claim 5, wherein the certain ratio is 2 to 1, when the rotatable stand is of the same length as the side of the tablet on the rotation plane of the rotatable stand.

7. The tablet holder of claim 1, wherein the optical wireless communication is Li-Fi communication.

8. The tablet holder of claim 1, wherein the rotatable housing is a cylinder truncated longitudinally.

9. The tablet holder of claim 1, wherein the motion transmission subsystem comprises at least one of a pair of gears, a pair of friction wheels, a pair of friction belts, a pair of chain and sprocket.

10. The tablet holder of claim 9, wherein the motion transmission subsystem is a gear solution comprising a first gear of the gear solution coupled to or integrated in the rotatable stand and a second gear of the gear solution coupled to or integrated in the rotatable housing.

11. The tablet holder of claim 10, wherein the gear solution comprises more than one pair of mating gears, with each pair of mating gears having a different gear ratio and coupled to or integrated in the rotatable stand and the rotatable housing, respectively; and the gear solution is configured to engage one pair of mating gears each time.

12. The tablet holder of claim 1, wherein the motion transmission subsystem comprises an end position of either the rotatable housing or the rotatable stand, and the end position corresponds to a position where the rotatable stand has the certain angle against the supporting surface.

13. The tablet holder of claim 1, wherein the optical transceiver is configured to carry out optical wireless communication with an optical access point, and the orientation of the optical transceiver remains facing the optical access point when the rotatable stand is in the closed state or is rotated to the extended state with the rotatable stand having the certain angle against the supporting surface.

14. The tablet holder of claim 1, wherein the optical transceiver has a beam angle not larger than 60 degrees.

15. The tablet holder of claim 14, wherein the optical transceiver has a beam angle not larger than 30 degrees.
